(19) United States
(12) Patent Application Publication
(10) Pub. No.: US 2024/0015738 A1
(43) Pub. Date: Jan. 11, 2024

(54) COMMUNICATIONS METHOD, COMMUNICATIONS APPARATUS, COMPUTER-READABLE STORAGE MEDIUM, AND CHIP

(71) Applicant: HUAWEI TECHNOLOGIES CO., LTD., Shenzhen (CN)

(72) Inventors: Zhe LIU, Shanghai (CN); Chenghui PENG, Shanghai (CN); Jianjun WU, Shenzhen (CN)

(21) Appl. No.: 18/473,519

(22) Filed: Sep. 25, 2023

Related U.S. Application Data
(63) Continuation of application No. PCT/CN2022/076682, filed on Feb. 17, 2022.

(30) Foreign Application Priority Data
Mar. 31, 2021 (CN) 202110350339.4

(51) Int. Cl. H04W 72/1268; H04W 72/232

(52) U.S. Cl. CPC H04W 72/1268; H04W 72/232

(57) ABSTRACT

A terminal device sends recommendation information to a network device. The recommendation information indicates a recommendation of the terminal device for performing uplink scheduling by the network device. The terminal device receives a configuration parameter of uplink scheduling from the network device. The recommendation information is included in an RRC message, and includes periodicity information or time domain offset information for grant-free scheduling, or periodicity information or time domain offset information of PDCCH monitoring for grant-based scheduling. The recommendation information further includes at least one of the following: validity time information, probability information, target information, or reward feedback information.

### CROSS-REFERENCE TO RELATED APPLICATIONS

This application is a continuation of International Application No. PCT/CN2022/076682, filed on Feb. 17, 2022, which claims priority to Chinese Patent Application No. 202110350339.4, filed on Mar. 31, 2021. The disclosures of the aforementioned applications are hereby incorporated by reference in their entireties.

### BACKGROUND

A network device needs to first schedule an uplink transmission resource of a terminal device, and then the terminal device performs uplink transmission by using the scheduled uplink transmission resource. Generally, a mode in which the network device performs scheduling includes a grant-free scheduling mode and a grant-based scheduling mode.

However, in both the grant-free scheduling mode and the grant-based scheduling mode, how to implement a configuration of uplink scheduling is a problem worth considering.

### SUMMARY

Example embodiments described herein provide a solution for determining a configuration of uplink scheduling in a communications system.

According to a first aspect, a communications method is provided. The communications method includes: A terminal device sends recommendation information to a network device. The recommendation information indicates a recommendation of the terminal device for performing uplink scheduling by the network device. In addition, the terminal device receives a configuration parameter of uplink scheduling from the network device.

In this way, the terminal device provides the recommendation information to the network device, so that the network device determines the configuration parameter of uplink scheduling based on the recommendation information, more comprehensive information is considered by the network device, uplink scheduling is more accurately configured, and optimized resource utilization is further facilitated.

In some embodiments of the first aspect, the recommendation information includes at least one of the following for uplink grant-free scheduling: periodicity information or time domain offset information. In this way, the terminal device provides a recommendation for a periodicity or a time domain offset of uplink grant-free scheduling to the network device by using the recommendation information, so that the network device determines the configuration parameter of uplink scheduling based on the recommendation.

In some embodiments of the first aspect, the recommendation information includes at least one of the following for uplink grant-based scheduling: periodicity information of physical downlink control channel (PDCCH) monitoring or time domain offset information of PDCCH monitoring. In this way, the terminal device provides a recommendation for a periodicity of PDCCH monitoring or a time domain offset of PDCCH monitoring for uplink grant-based scheduling to the network device by using the recommendation information, so that the network device determines the configuration parameter of uplink scheduling based on the recommendation.

In some embodiments of the first aspect, the recommendation information includes at least one of the following for uplink transmission: a number of repetitions, a modulation and coding scheme MCS, or spectral efficiency of an MCS. In this way, the terminal device provides a recommendation for an uplink transmission resource to the network device by using the recommendation information, so that the network device more intuitively obtains an uplink transmission parameter of the terminal device, thereby ensuring that the configuration parameter of uplink scheduling that is determined by the network device is more accurate.

In some embodiments of the first aspect, the recommendation information further includes at least one of the following: validity time information, probability information, target information, or reward feedback information. In this way, the terminal device further provides more abundant reference information to the network device, so that the network device determines the configuration parameter of uplink scheduling based on the reference information, and the network device makes a decision based on more comprehensive factors, thereby improving accuracy of the decision, and implementing a proper resource configuration.

In some embodiments of the first aspect, that a terminal device sends recommendation information to a network device includes: The terminal device sends a radio resource control RRC message to the network device. The RRC message includes the recommendation information, and the RRC message is one of the following messages: an RRC connection resume complete message, an RRC setup complete message, an RRC reconfiguration complete message, and an RRC recommendation message. In this way, the recommendation information is transmitted by using the RRC message, so that an existing RRC format is fully utilized, and the network device accurately obtains the recommendation information in a timely manner.

According to a second aspect, a communications method is provided. The communications method includes: A network device receives recommendation information from a terminal device. The recommendation information indicates a recommendation of the terminal device for performing uplink scheduling by the network device. The network device determines a configuration parameter of uplink scheduling based on the recommendation information. In addition, the network device sends the configuration parameter to the terminal device.

In this way, the network device receives the recommendation information of the terminal device for uplink scheduling, and determines the configuration parameter of uplink scheduling based on the recommendation information. In this solution, more comprehensive information is considered by the network device during configuration, and the configuration parameter of uplink scheduling is more accurately determined, so that optimized resource utilization is further facilitated.

In some embodiments of the second aspect, the recommendation information includes at least one of the following for uplink grant-free scheduling: periodicity information or time domain offset information.

In some embodiments of the second aspect, the recommendation information includes at least one of the following for uplink grant-based scheduling: periodicity information of physical downlink control channel (PDCCH) monitoring or time domain offset information of PDCCH monitoring.

In some embodiments of the second aspect, the recommendation information includes at least one of the following for uplink transmission: a number of repetitions, a modulation and coding scheme MCS, or spectral efficiency of an MCS. In this way, the network device learns a more direct recommendation of the terminal device for an uplink transmission resource by using the recommendation information, so that an uplink transmission parameter of the terminal device is more intuitively obtained, thereby ensuring that the determined configuration parameter of uplink scheduling is more accurate.

In some embodiments of the second aspect, the recommendation information further includes at least one of the following: validity time information, probability information, target information, or reward feedback information. In this way, the network device learns more abundant reference information of the terminal device with respect to the recommendation information, so that the network device determines the configuration parameter of the uplink scheduling based on the reference information, and the network device makes a decision based on more comprehensive factors, thereby improving accuracy of the decision, and implementing a proper resource configuration.

In some embodiments of the second aspect, that a network device receives recommendation information from a terminal device includes: The network device receives a radio resource control RRC message from the terminal device. The RRC message includes the recommendation information, and the RRC message is one of the following messages: an RRC connection resume complete message, an RRC setup complete message, an RRC reconfiguration complete message, and an RRC recommendation message. In this way, the recommendation information in at least one embodiment is transmitted by using the RRC message, so that an existing RRC format is fully utilized, and the network device accurately obtains the recommendation information in a timely manner.

In some embodiments of the second aspect, that the network device determines a configuration parameter of uplink scheduling based on the recommendation information includes: The network device determines the configuration parameter based on the recommendation information and a load status of the network device. In this way, the network device determines the configuration parameter by comprehensively considering a factor of the terminal device and a factor of the network device, so that more comprehensive factors are considered, and the determined configuration parameter is more accurate.

According to a third aspect, a communications apparatus is provided. The communications apparatus includes: a sending unit, configured to send recommendation information to a network device, where the recommendation information indicates a recommendation of a terminal device for performing uplink scheduling by the network device; and a receiving unit, configured to receive a configuration parameter of uplink scheduling from the network device. The communications apparatus is implemented at the terminal device. For example, the communications apparatus includes the terminal device or include a chip in the terminal device.

In some embodiments of the third aspect, the recommendation information includes at least one of the following for uplink grant-free scheduling: periodicity information or time domain offset information.

In some embodiments of the third aspect, the recommendation information includes at least one of the following for uplink grant-based scheduling: periodicity information of physical downlink control channel (PDCCH) monitoring or time domain offset information of PDCCH monitoring.

In some embodiments of the third aspect, the recommendation information includes at least one of the following for uplink transmission: a number of repetitions, a modulation and coding scheme MCS, or spectral efficiency of an MCS.

In some embodiments of the third aspect, the recommendation information further includes at least one of the following: validity time information, probability information, target information, or reward feedback information.

In some embodiments of the third aspect, the sending unit is configured to: send a radio resource control RRC message to the network device. The RRC message includes the recommendation information, and the RRC message is one of the following messages: an RRC connection resume complete message, an RRC setup complete message, an RRC reconfiguration complete message, and an RRC recommendation message.

According to a fourth aspect, a communications apparatus is provided. The communications apparatus includes: a receiving unit, configured to receive recommendation information from a terminal device, where the recommendation information indicates a recommendation of the terminal device for performing uplink scheduling by a network device; a determining unit, configured to determine a configuration parameter of uplink scheduling based on the recommendation information; and a sending unit, configured to send the configuration parameter to the terminal device. The communications apparatus is implemented at the network device. For example, the communications apparatus includes the network device or include a chip in a network device.

In some embodiments of the fourth aspect, the recommendation information includes at least one of the following for uplink grant-free scheduling: periodicity information or time domain offset information.

In some embodiments of the fourth aspect, the recommendation information includes at least one of the following for uplink grant-based scheduling: periodicity information of physical downlink control channel (PDCCH) monitoring or time domain offset information of PDCCH monitoring.

In some embodiments of the fourth aspect, the recommendation information includes at least one of the following for uplink transmission: a number of repetitions, a modulation and coding scheme MCS, or spectral efficiency of an MCS.

In some embodiments of the fourth aspect, the recommendation information further includes at least one of the following: validity time information, probability information, target information, or reward feedback information.

In some embodiments of the fourth aspect, the receiving unit is configured to: receive a radio resource control RRC message from the terminal device. The RRC message includes the recommendation information, and the RRC message is one of the following messages: an RRC connection resume complete message, an RRC setup complete message, an RRC reconfiguration complete message, and an RRC recommendation message.

In some embodiments of the fourth aspect, the determining unit is configured to: determine the configuration parameter based on the recommendation information and a load status of the network device.

According to a fifth aspect, a terminal device is provided. The terminal device includes: at least one processor and at least one memory. The at least one memory is coupled to the at least one processor, and stores instructions for execution by the at least one processor. In response to being executed by the at least one processor, the instructions enable the terminal device to implement: sending recommendation information to a network device, where the recommendation information indicates a recommendation of the terminal device for performing uplink scheduling by the network device; and receiving a configuration parameter of uplink scheduling from the network device.

In some embodiments of the fifth aspect, the recommendation information includes at least one of the following for uplink grant-free scheduling: periodicity information or time domain offset information.

In some embodiments of the fifth aspect, the recommendation information includes at least one of the following for uplink grant-based scheduling: periodicity information of physical downlink control channel (PDCCH) monitoring or time domain offset information of PDCCH monitoring.

In some embodiments of the fifth aspect, the recommendation information includes at least one of the following for uplink transmission: a number of repetitions, a modulation and coding scheme MCS, or spectral efficiency of an MCS.

In some embodiments of the fifth aspect, the recommendation information further includes at least one of the following: validity time information, probability information, target information, or reward feedback information.

In some embodiments of the fifth aspect, in response to being executed by the at least one processor, the instructions enable the terminal device to implement: sending a radio resource control RRC message to the network device. The RRC message includes the recommendation information, and the RRC message is one of the following messages: an RRC connection resume complete message, an RRC setup complete message, an RRC reconfiguration complete message, or an RRC recommendation message.

According to a sixth aspect, a network device is provided. The network device includes: at least one processor and at least one memory. The at least one memory is coupled to the at least one processor, and stores instructions for execution by the at least one processor. In response to being executed by the at least one processor, the instructions enable the network device to implement: receiving recommendation information from a terminal device, where the recommendation information indicates a recommendation of the terminal device for performing uplink scheduling by the network device; determining a configuration parameter of uplink scheduling based on the recommendation information; and sending the configuration parameter to the terminal device.

In some embodiments of the sixth aspect, the recommendation information includes at least one of the following for uplink grant-free scheduling: periodicity information or time domain offset information.

In some embodiments of the sixth aspect, the recommendation information includes at least one of the following for uplink grant-based scheduling: periodicity information of physical downlink control channel (PDCCH) monitoring or time domain offset information of PDCCH monitoring.

In some embodiments of the sixth aspect, the recommendation information includes at least one of the following for uplink transmission: a number of repetitions, a modulation and coding scheme MCS, or spectral efficiency of an MCS.

In some embodiments of the sixth aspect, the recommendation information further includes at least one of the following: validity time information, probability information, target information, or reward feedback information.

In some embodiments of the sixth aspect, in response to being executed by the at least one processor, the instructions enable the network device to implement: receiving a radio resource control RRC message from the terminal device. The RRC message includes the recommendation information, and the RRC message is one of the following messages: an RRC connection resume complete message, an RRC setup complete message, an RRC reconfiguration complete message, and an RRC recommendation message.

In some embodiments of the sixth aspect, in response to being executed by the at least one processor, the instructions enable the network device to implement: determining the configuration parameter based on the recommendation information and a load status of the network device.

According to a seventh aspect, a computer-readable storage medium is provided. The computer-readable storage medium stores a computer program, and in response to the computer program being executed by a processor, operations of the communications method according to any embodiment of the first aspect or the second aspect are implemented.

According to an eighth aspect, a chip is provided. The chip is configured to perform operations of the communications method according to any embodiment of the first aspect or the second aspect.

According to a ninth aspect, a computer program or a computer program product is provided. The computer program or the computer program product is tangibly stored in a computer-readable medium, and includes computer-executable instructions. In response to being executed, the computer-executable instructions enable a device to implement operations of the communications method according to any embodiment of the first aspect or the second aspect.

### BRIEF DESCRIPTION OF DRAWINGS

Features, advantages, and other aspects of implementations of embodiments described herein will become more apparent in conjunction with accompanying drawings and with reference to the following detailed descriptions. Several implementations of embodiments described herein are illustrated herein by way of example rather than limitation, in which:

FIG. 1 is a schematic diagram of a communications environment 100 according to at least one embodiment;

FIG. 2 is a schematic interaction diagram of a communications method 200 according to at least one embodiment;

FIG. 3 is a schematic diagram of a case 300 in which a terminal device determines that a periodicity of grant-free scheduling does not meet a service feature according to at least one embodiment;

FIG. 4 is a schematic diagram of a case 400 in which a terminal device determines that a periodicity of PDCCH monitoring of grant-based scheduling does not meet a service feature according to at least one embodiment;

FIG. 5 is a schematic block diagram of a communications apparatus 500 according to at least one embodiment;

FIG. 6 is a schematic block diagram of a communications apparatus 600 according to at least one embodiment; and

FIG. 7 is a simplified block diagram of an example device 700 according to at least one embodiment.

In the accompanying drawings, the same or similar reference numerals indicate the same or similar elements.

### DESCRIPTION OF EMBODIMENTS

At least one embodiment are described in more detail below with reference to accompanying drawings. Although at least one embodiment shown in accompanying drawings, at least one embodiment is implemented in various forms and should not be construed as limited to the embodiments set forth herein, but rather are provided for a more thorough and complete understanding of embodiments described herein. The accompanying drawings and embodiments described herein are merely used as examples, but are not intended to limit the protection scope of embodiments described herein.

In descriptions of embodiments herein, the term “including” and similar terms should be understood as an open inclusion, that is, “including but not limited to”. The term “based on” should be understood as “based at least in part on”. The term “one embodiment” or “this embodiment” should be understood as “at least one embodiment”. The terms “first”, “second”, and the like refers to different objects or a same object. Other explicit and implicit definitions is included below.

At least one embodiment is implemented based on any appropriate communications protocol, including but not limited to a cellular communications protocol such as a 3rd generation (3G), a 4th generation (4G), or a 5th generation (5G), a wireless local area network communications protocol such as the Institute of Electrical and Electronics Engineers (IEEE) 802.11, and/or any other protocol currently known or developed in the future.

Technical solutions of at least one embodiment is applied to any appropriate communications system, for example, a general packet radio service (GPRS), a global system for mobile communications (GSM), an enhanced data rate for GSM evolution (EDGE) system, a universal mobile telecommunications service (UMTS), a long term evolution (LTE) system, a wideband code division multiple access (WCDMA) system, a code division multiple access 2000 (CDMA2000) system, a time division-synchronous code division multiple access (TD-SCDMA) system, a frequency division duplex (FDD) system, a time division duplex (TDD) system, a narrowband internet of things (NB-IoT) communications system, a 5th generation (5G) system, or three major application scenarios of new radio (NR): enhanced mobile broadband (eMBB), ultra-reliable and low-latency communications (URLLC), and enhanced machine type communication (eMTC).

The technical solutions in at least one embodiment relate to a network device, and the network device includes an access network device. The access network device is an apparatus that is deployed in a radio access network to provide a wireless communications function for a mobile terminal, and is, for example, a radio access network (RAN) network device. The access network device includes various forms of base stations, for example, a macro base station, a micro base station (also referred to as a small cell), a relay station, an access point, a remote radio unit (RRU), a radio head (RH), or a remote radio head (RRH). The network device has different names in systems that use different radio access technologies, for example, referred to as an evolved NodeB (eNB, or eNodeB) in a long term evolution (LTE) system, referred to as a NodeB (NB) in a 3G system, and referred to as a g NodeB (gNB) or an NR NodeB (NR NB) in a 5G network. In some scenarios, the network device includes a central unit (CU) and a distributed unit (DU). The CU and the DU is placed in different places. For example, the DU is deployed remotely in an area with heavy traffic, and the CU is deployed in a central equipment room. Alternatively, the CU and the DU is placed in a same equipment room. Alternatively, the CU and the DU is different components in one rack. For ease of description, in subsequent embodiments described herein, the foregoing apparatuses that provide a wireless communications function for a mobile terminal are collectively referred to as a network device, and the network device in at least one embodiment also refers to an access network device, which are not deliberately distinguished below.

The technical solutions of at least one embodiment relate to a mobile terminal, and optionally, the mobile terminal is also referred to as a mobile station (MS). The mobile terminal in at least one embodiment includes various handheld devices, in-vehicle devices, wearable devices, computing devices, or other processing devices connected to a wireless modem that have a wireless communications function. The mobile terminal in at least one embodiment is also referred to as a terminal or user equipment (UE), and is a subscriber unit, a cellular phone (cellular phone or cell phone), a smartphone, a wireless data card, a personal digital assistant computer, a tablet computer, a wireless modem, a handset, a laptop computer, a machine type communication (MTC) terminal, or the like. The terminal device in at least one embodiment has uplink traffic to be transmitted to the network device. In some cases, the terminal device further receives downlink traffic from the network device. An uplink traffic volume of the terminal device is greater than or basically equal to a downlink traffic volume. For example, the terminal device is a terminal device performing a live broadcast service or a terminal device in a vertical industry.

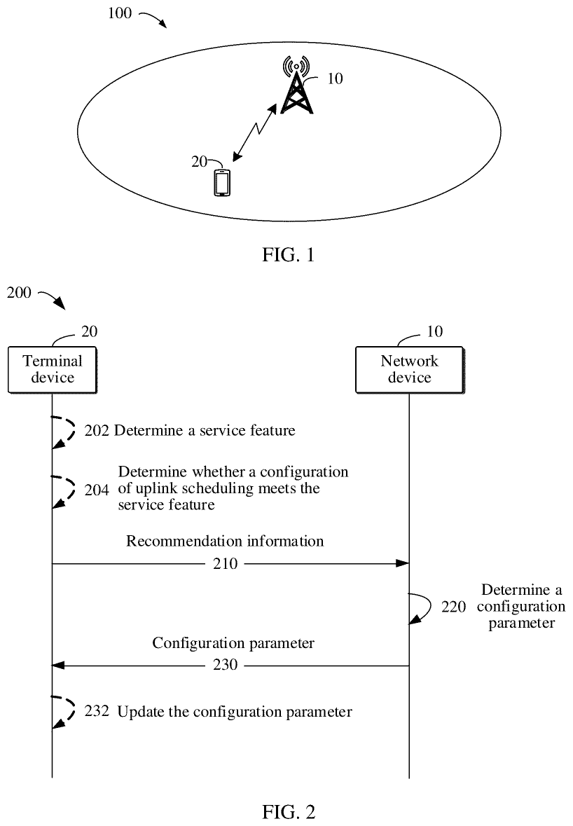

FIG. 1 is a schematic diagram of a communications environment 100 according to at least one embodiment. As shown in FIG. 1, the communications environment 100 includes a network device 10 and a terminal device 20. The network device 10 and the terminal device 20 communicates with each other.

The communications environment 100 includes any appropriate number of devices and cells. In the communications environment 100, the terminal device 20 and the network device 10 communicates data and control information with each other. The numbers of devices shown in FIG. 1 and connections between the devices are given for a purpose of illustration, and are not limited. The communications environment 100 includes any appropriate number of devices and networks suitable for implementing embodiments described herein.

Communication in the communications environment 100 is implemented based on any appropriate communications protocol, including but not limited to a 1st generation cellular communications protocol (1G), a 2nd generation cellular communications protocol (2G), a 3rd generation cellular communications protocol (3G), a 4th generation cellular communications protocol (4G), a 5th generation cellular communications protocol (5G), a wireless local area network communications protocol such as the Institute of Electrical and Electronics Engineers (IEEE) 802.11, and/or any other protocol currently known or developed in the future. In addition, communication uses any appropriate wireless communications technology, including but not limited to code division multiple access (CDMA), frequency division multiple access (FDMA), time division multiple access (TDMA), frequency division duplex (Duplex FDD), time division duplex (TDD), multiple-input multiple-output (MIMO), orthogonal frequency division multiplexing (OFDM), discrete Fourier transform-spread-OFDM (DFT-s-OFDM), and/or any other technology currently known or developed in the future.

A mode in which the network device schedules an uplink transmission resource of the terminal device includes a grant-based scheduling mode and a grant-free scheduling mode.

In the grant-based scheduling mode, the network device notifies the terminal device of a time-frequency resource for uplink transmission by using a physical downlink control channel (PDCCH). Before that, the network device needs to preconfigure a periodicity of PDCCH monitoring and a time domain offset of PDCCH monitoring, so that the terminal device determines a transmission occasion of the PDCCH in time domain. However, a service feature of uplink transmitted data on the terminal device changes. In response to the periodicity of PDCCH monitoring and the time domain offset of PDCCH monitoring that are preconfigured by the network device not matching the service feature, a delay of the uplink transmitted data on the terminal device increases. “Monitoring (monitor)” is also referred to as another action such as listening, detection, blind detection, sensing, or the like. This is not limited in at least one embodiment.

In the grant-free scheduling mode, the network device preconfigures, by using radio resource control (RRC), a grant-free periodicity for performing uplink transmission by the terminal device. However, a service feature of uplink transmitted data on the terminal device changes. In response to the grant-free periodicity preconfigured by the network device not matching the service feature, a delay of the uplink transmitted data on the terminal device increases.

Example embodiments described herein are discussed in detail below with reference to accompanying drawings. In the following description of an example method procedure in FIG. 2, for ease of discussion, example embodiments herein are described with reference to the example communications environment in FIG. 1. Example embodiments are similarly applied to other communications environments.

FIG. 2 is a schematic interaction diagram of a communications method 200 according to at least one embodiment. FIG. 2 includes the network device 10 and the terminal device 20. It is understood that a communications process shown in FIG. 2 is merely an example, rather than limitative. At least one embodiment includes exchanged signaling that is not shown in FIG. 2, or some signaling shown in FIG. 2 is omitted.

As shown in FIG. 2, the terminal device 20 sends 210 recommendation information to the network device 10. The recommendation information indicates a recommendation of the terminal device 20 for performing uplink scheduling by the network device 10.

In some embodiments, the terminal device 20 sends an RRC message to the network device 10. The RRC message includes the recommendation information. In other words, the recommendation information is included in an RRC message, or the recommendation information is sent by using an RRC message. Optionally, the RRC message is any RRC message before the 3GPP standard release 16 (R16). Alternatively, the RRC message is any RRC message in or after R16.

In an embodiment, the RRC message is an RRC connection resume complete message. In other words, the terminal device 20 sends 210 an RRC connection resume complete message to the network device 10, and the RRC connection resume complete message includes the recommendation information.

In another embodiment, the RRC message is an RRC setup complete message. In other words, the terminal device 20 sends 210 an RRC setup complete message to the network device 10, and the RRC setup complete message includes the recommendation information.

In still another embodiment, the RRC message is an RRC reconfiguration complete message. In other words, the terminal device 20 sends 210 an RRC reconfiguration complete message to the network device 10, and the RRC reconfiguration complete message includes the recommendation information.

In some embodiments, an RRC message is newly defined to send the recommendation information. For example, the newly defined RRC message is an RRC recommendation message, an AI assistance message, or another message. In an embodiment, the RRC message is an RRC recommendation message. In other words, the terminal device 20 sends 210 an RRC recommendation message to the network device 10, and the RRC recommendation message includes the recommendation information.

For example, in response to the terminal device 20 sending the recommendation information 210 by using the RRC message, the recommendation information is carried in one or more specific fields of the RRC message. In some embodiments, the specific field is a reserved field, a newly defined field, an existing field, or the like. In an example, the recommendation information is transmitted by using a reserved field in the RRC message. In another example, the recommendation information is transmitted by using an existing field in the RRC message, for example, a UE assistance information field (UEAssistanceInformation). In still another example, the recommendation information is transmitted by using a newly defined additional field in the RRC message, which is, for example, an additionally defined AI assistance information field in the RRC recommendation message or the AI assistance message.

In this way, in at least one embodiment, the recommendation information is transmitted by using the RRC message, so that an existing RRC format is fully utilized, and the network device 10 accurately obtains the recommendation information in a timely manner.

Although the recommendation information is transmitted by using the RRC message above, at least one embodiment is not limited thereto. For example, the recommendation information is sent by using another RRC message or by using another control message other than the RRC message. This is not limited in at least one embodiment.

Based on different modes of performing uplink scheduling by the network device 10, two different implementations are discussed in at least one embodiment. One implementation is for the grant-free scheduling mode, and the other implementation is for the grant-based scheduling mode.

In the implementation for the grant-free scheduling mode, the network device 10 configures, in advance for the terminal device 20 by using RRC signaling, a parameter used in the grant-free scheduling mode. The parameter includes at least a periodicity of grant-free scheduling.

The grant-free scheduling mode includes two types. A type 1 is grant-free scheduling that takes effect immediately after the RRC configuration, and a type 2 is grant-free scheduling that takes effect in response to DCI activation being performed after the RRC configuration.

Specifically, the network device 10 indicates a type in a specific field in the RRC signaling. For example, the RRC signaling is an information element (IE) configured grant configuration (IE ConfiguredGrantConfig), and the specific field is an RRC configured uplink grant (rrc-ConfiguredUplinkGrant). For example, in response to rrc-ConfiguredUplinkGrant being configured, the type 1 is indicated. In response to rrc-ConfiguredUplinkGrant not being configured, the type 2 is indicated.

The parameter for grant-free scheduling that is configured by the network device 10 includes at least a periodicity. In some embodiments, the parameter further includes at least one of the following for uplink transmission: a number of hybrid automatic repeat request (HARQ) processes (nrofHARQ-Processes), power control, a number of repetitions (repK), a repeated redundancy version (repK-RV), or the like. In addition, for the type 1, the parameter further includes: a time domain resource, a frequency domain resource, a modulation and coding scheme (MCS), an antenna port, an SRS resource indicator, a demodulation reference signal (DMRS), or the like. For the type 2, downlink control information (DCI) scrambled by a configured scheduling radio network temporary identifier (Configured Scheduling Radio Network Temporary Identifier, CS-RNTI) indicates activation, and carries a related parameter such as a time domain resource, a frequency domain resource, or a modulation and coding scheme (MCS).

A parameter periodicity is configured for both the type 1 and the type 2. Therefore, the terminal device 20 periodically transmits uplink data on a physical uplink shared channel (PUSCH).

Specifically, for the type 1, a time domain offset (timeDomainOffset) is further configured in the RRC signaling, so that the terminal device 20 determines an uplink transmission location in each periodicity by using the time domain offset. For example, a transmission location in an N^{th} grant-free periodicity is represented as follows:

[(SFN×numberOfSlotsPerFrame×numberOfSymbolsPerSlot)+(slot number in the frame×numberOfSymbolsPerSlot)+symbol number in the slot]=(timeDomainOffset+N×periodicity)modulo(1024×numberOfSlotsPerFrame×numberOfSymbolsPerSlot),

where SFN represents a system frame number, numberOfSlotsPerFrame represents the number of slots in each frame, numberOfSymbolsPerSlot represents the number of symbols in each slot, slot number in the frame represents a slot location in the frame, symbol number in the slot indicates a symbol location in the slot, periodicity indicates a periodicity, timeDomainOffset indicates a time domain offset, and modulo indicates a modulo operation.

For the type 2, the terminal device 20 determines an uplink transmission location in each periodicity based on a parameter included in the DCI activation. For example, a transmission location in an N^{th} grant-free periodicity is represented as follows:

[(SFN×numberOfSlotsPerFrame×numberOfSymbolsPerSlot)+(slot number in the frame×numberOfSymbolsPerSlot)+symbol number in the slot]=[(SFN_{start time}×numberOfSlotsPerFrame×numberOfSymbolsPerSlot+slot_{start time}×numberOfSymbolsPerSlot+symbol_{start time})+N×periodicity] modulo(1024×numberOfSlotsPerFrame×numberOfSymbolsPerSlot),

where SFN represents a system frame number, numberOfSlotsPerFrame represents the number of slots in each frame, numberOfSymbolsPerSlot represents the number of symbols in each slot, slot number in the frame represents a slot location in the frame, symbol number in the slot indicates a symbol location in the slot, periodicity indicates a periodicity, SFN_{start time}, slot_{start time}, and symbol_{start time} respectively indicate a system frame number, a slot, and a symbol of the first uplink transmission of the terminal device 20 after the DCI activation, and modulo indicates a modulo operation.

In the implementation for grant-free scheduling, the recommendation information includes periodicity information and/or time domain offset information for uplink grant-free scheduling.

Additionally or alternatively, before step 210 in FIG. 2, the method further includes a process in which the terminal device 20 determines and generates the recommendation information. As shown in FIG. 2, the terminal device 20 determines 202 a service feature of uplink data to be transmitted, and determine 204 whether a configuration of uplink scheduling meets the service feature. Further, in response to determining that the service feature is not met, the terminal device 20 sends 210 the recommendation information.

In the implementation for grant-free scheduling, the terminal device 20 determines 204 whether the parameter of grant-free scheduling meets the service feature. Correspondingly, the recommendation information includes periodicity information and/or time domain offset information for grant-free scheduling.

In some embodiments, the service feature of the uplink data to be transmitted is determined by using a service prediction algorithm. Optionally, the service prediction algorithm used by the terminal device 20 is an artificial intelligence (AI) algorithm, for example, is a conventional machine learning algorithm or deep learning algorithm.

Generally, machine learning is classified into three types based on training methods: supervised learning, unsupervised learning, and reinforcement learning. Supervised learning means giving the algorithm a data set and a correct answer (labeling data). A machine uses the data to learn a processing method of the correct answer. Such a manner of helping the machine in learning through a lot of manual labeling is supervised learning. This learning manner is effective, but costs much. In unsupervised learning, there is no “correct answer” for a given data set, and all data is equal. A task of unsupervised learning is to mine a potential structure from the given data set. Reinforcement learning is closer to essence of biological learning, and therefore is expected to achieve higher intelligence. Reinforcement learning focuses on how an agent takes a series of behavior in an environment to maximize a cumulative return. Through reinforcement learning, the agent should know behavior that should be taken in a state. In reinforcement learning, there are two types of methods. One is value-based, and the other is policy-based. An actor-critic method is obtained by combining the two. Therefore, a policy gradient method uses an actor-critic framework, the actor models a policy, and the critic models a value function. In policy-based reinforcement learning, a policy generates probabilities corresponding to a series of actions in a discrete action space, and generates a probability density of a continuous action space for a continuous space. An action corresponding to a maximum probability or probability density generated by the policy is executed with a high probability (to implement a maximum cumulative return obtained by using the policy), and then an action corresponding to a randomly selected probability is executed with a low probability (a new action explored achieves a higher cumulative return).

In some embodiments, the service prediction algorithm determines, based on historical data of the terminal device 20 by using a method such as regression analysis, the service feature of the uplink data to be transmitted.

In a process in which a user uses the terminal device 20, uplink data transmitted by using the terminal device 20 shows a regularity. For example, a data amount is positively correlated to a behavior pattern of using an application (APP) on the terminal device 20 by the user, which has a regularity. For example, a data amount on weekends is greater than that on weekdays, a data amount at night is greater than that in daytime, and a daily traffic volume fluctuates, including a peak and a valley. Therefore, predicting uplink transmitted traffic in real time is feasible by using historical data.

Regression is a method that mainly performs prediction based on a “mean value” of historical data (for example, over a period of time in the past). Regression is implemented in many manners, including but not limited to linear regression, logistic regression, polynomial regression, stepwise regression, ridge regression, lasso regression, elasticnet regression, or the like. Regression is essentially curve fitting, which predicts a “conditional mean value” of different models. However, in regression analysis, a desire for unbiased prediction of historical data fails to guarantee accuracy of predicted future data.

In some embodiments, the service prediction algorithm determines, based on historical data of the terminal device 20 by using a machine learning algorithm, the service feature of the uplink data to be transmitted. The machine learning algorithm is a conventional machine learning algorithm or deep learning algorithm.

Different from regression analysis, the machine learning algorithm does not pursue accuracy of a mean value in response to prediction being performed, which allows a deviation, but aims to reduce a variance. As a data amount grows continuously and computing power increases continuously, an effect of performing prediction by using the machine learning algorithm is better than that of another method. The machine learning algorithm is also referred to as an AI prediction algorithm, a traffic prediction algorithm, or the like, and includes a deep learning algorithm based on a neural network. The neural network includes but is not limited to a back propagation network, an Elman neural network, a long short term memory neural network, or the like.

For example, a training data set is constructed by using historical data, and the training data set includes a large volume of training data. Subsequently, training is performed based on the training data set, to obtain a neural network structure that converges or meets a training end condition (for example, defined by using a loss function). In some examples, a validation set is further constructed for validation on the trained neural network. Therefore, the trained neural network is used to perform service prediction, to obtain the service feature of the uplink data to be transmitted.

The AI algorithm performs training based on a large volume of data, and includes a large number of training parameters to comprehensively consider various factors. Therefore, in at least one embodiment, in response to the terminal device 20 determining the service feature by using the AI algorithm, various factors is also fully considered, so that the determined service feature is more accurate and is reliable. This prevents inaccurate prediction from causing inaccurate resource allocation and affecting resource utilization.

The service feature is also referred to as a service status or another name, and indicates some service attributes related to service transmission. The service status includes, for example, a time of arrival, an arrival periodicity, a transport packet size, and/or service transmission channel quality. The foregoing examples of the service status are merely illustrative, rather than limitative, and the service status further includes other service-related information.

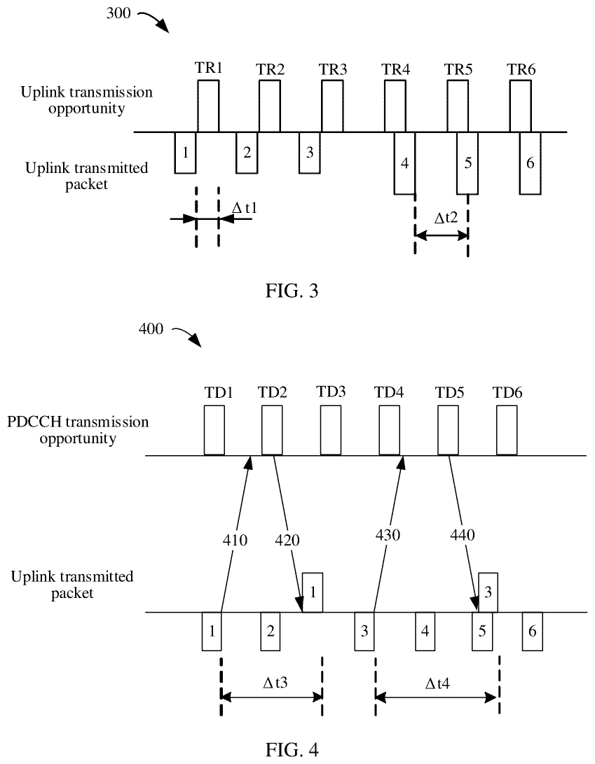

FIG. 3 is a schematic diagram of a case 300 in which the terminal device 20 determines that a periodicity of grant-free scheduling does not meet a service feature according to at least one embodiment. As shown in FIG. 3, the network device 10 preconfigures a periodicity of grant-free scheduling, and correspondingly, grant-free uplink transmission (TR) occasions are represented as TR1, TR2, . . . , TR6, and the like. Uplink data transmitted by the terminal device 20 to the network device 10 includes a packet 1, a packet 2, a packet 3, . . . , a packet 6, and the like. The terminal device 20 determines, in a process of transmitting the packet 1 and the packet 2, a service feature of subsequent uplink data to be transmitted, and determine whether the periodicity of grant-free scheduling meets the service feature.

For example, the terminal device 20 determines that a time of arrival of the uplink data to be transmitted changes (for example, later), but an arrival periodicity does not change. In this case, based on the preconfigured periodicity of grant-free scheduling, a waiting time for performing uplink service transmission increases. As a result, an uplink transmission delay increases.

As shown in FIG. 3, uplink transmission is performed at the uplink transmission occasion TR1 for the packet 1 at the terminal device 20. Similarly, uplink transmission is performed at the uplink transmission occasion TR2 for the packet 2, and uplink transmission is performed at the uplink transmission occasion TR3 for the packet 3. In the uplink transmission of the packet 1 to the packet 3, a waiting time for each transmission is Δt1. In some embodiments, in a process of transmitting the packet 1 to the packet 3, the terminal device 20 determines, in a manner such as prediction, that a time of arrival of the packet 4 is delayed, that is, a time interval between the time of arrival of the packet 4 and a time of arrival of the packet 3 is greater than a time interval between those of the packet 3 and the packet 2. In this case, after the packet 4 arrives, uplink transmission is performed only at the uplink transmission occasion TR5 at the earliest. After that, although the packet arrival periodicity does not change, a waiting time for each packet becomes longer, for example, becomes Δt2. Therefore, the terminal device 20 determines that a transmission delay after the packet 4 increases. Therefore, the terminal device 20 determines that the periodicity of grant-free scheduling does not meet the service feature.

For another example, the terminal device 20 determines that an arrival periodicity of the uplink data to be transmitted changes (for example, increases or decreases). In this case, based on the preconfigured periodicity of grant-free scheduling, a waiting time for performing uplink service transmission increases. As a result, an uplink transmission delay increases. This example is similar to the case in FIG. 3, and is not described in detail herein.

Only some examples are provided above, which are not limitative, and there is other cases in which a periodicity of grant-free scheduling cannot meet a service feature of uplink data to be transmitted, which are not listed one by one herein.

For example, the terminal device 20 generates the recommendation information based on the determined service feature of the uplink data to be transmitted and the periodicity of grant-free scheduling, and further send 210 the recommendation information to the network device 10.

In some embodiments, the recommendation information includes periodicity information for uplink grant-free scheduling. The recommendation information indicates an update recommendation of the terminal device 20 for the periodicity of uplink grant-free scheduling. Optionally, the periodicity information is a specific periodicity value in the number of slots, the number of symbols, or others. The periodicity information is carried in a periodicity preference field (periodicityPreference). For example, for a value range of the periodicity information, sym2, sym7, sym1*14, sym2*14, . . . , or sym5120*14 is used to respectively indicate that the periodicity information is 2 symbols, 7 symbols, 1*14 symbols, 2*14 symbols, . . . , or 5120*14 symbols. Optionally, the periodicity information is periodicity increase or decrease indication information, and is represented in a manner such as a choice (CHOICE) structure or an enumerate (ENUMERATE) structure. This is not limited in at least one embodiment.

In some embodiments, for the type 1 in grant-free scheduling, the recommendation information includes time domain offset information for uplink grant-free scheduling. The recommendation information indicates an update recommendation of the terminal device 20 for the time domain offset of uplink grant-free scheduling. Optionally, the time domain offset information is a specific time domain offset value in the number of slots, the number of symbols, or others. The time domain offset information is carried in a time domain offset preference field (timeDomainOffsetPreference). For example, the time domain offset is preset in the number of symbols. In this case, for a value range of the time domain offset, refer to a range in a downlink configuration. For example, an integer INTEGER (0 . . . 5119) respectively indicates that the time domain offset is (0 . . . 5119) symbols. Optionally, the time domain offset information is offset increase or decrease indication information, and is represented in a manner such as a choice (CHOICE) structure or an enumerate (ENUMERATE) structure. This is not limited in at least one embodiment.

The implementation for the grant-free scheduling mode is described above, and the implementation for grant-based scheduling is similarly described below.

In the implementation for the grant-based scheduling mode, in response to the terminal device 20 having to-be-transmitted uplink data, the terminal device 20 needs to first request an uplink transmission resource from the network device 10, and then the network device 10 performs scheduling based on the request.

Specifically, in response to the terminal device 20 has to-be-transmitted uplink data, in response to the terminal device 20 already having a physical uplink control channel (PUCCH) transmission resource, the terminal device 20 sends a scheduling request (Scheduling Request, SR) to the network device 10 by using a PUCCH. In response to the terminal device 20 having no PUCCH transmission resource, the terminal device 20 sends a scheduling request (SR) to the network device 10 by using a physical random access channel (PRACH). The SR notifies the network device 10 that the terminal device 20 has to-be-transmitted uplink data. Optionally, the terminal device 20 further notifies the network device 10 of a data amount of the to-be-transmitted uplink data by using a buffer status report (BSR).

After receiving the SR and/or the BSR, the network device 10 schedules a physical uplink shared channel (PUSCH), and indicate a transmission resource of the PUSCH by using uplink scheduling grant downlink control information (DCI) in a PDCCH. However, the transmission performed by using the PDCCH is limited by a PDCCH time-frequency location that is monitored by the terminal device 20.

Generally, the network device 10 notifies the terminal device 20 of a periodicity of PDCCH monitoring and a time domain offset of PDCCH monitoring by using a preconfiguration. The periodicity of PDCCH monitoring indicates an interval between two adjacent PDCCH transmission occasions. The time domain offset of PDCCH monitoring indicates an offset relative to a reference start point of a periodicity during one transmission, and is used to determine a specific transmission location. The terminal device 20 monitors, based on the configuration and at the determined time-frequency resource location for monitoring the PDCCH, the PDCCH delivered by the network device 10. Therefore, the terminal device 20 learns, based on the uplink scheduling grant DCI in the PDCCH, the transmission resource of the PUSCH that is indicated by the network device 10.

In the implementation for grant-based scheduling, the recommendation information includes periodicity information of PDCCH monitoring and/or time domain offset information of PDCCH monitoring for uplink grant-based scheduling.

Additionally or alternatively, before step 210 in FIG. 2, the method further includes a process in which the terminal device 20 determines and generates the recommendation information. As shown in FIG. 2, the terminal device 20 determines 202 a service feature of uplink data to be transmitted, and determine 204 whether a configuration of uplink scheduling meets the service feature. Further, in response to determining that the service feature is not met, the terminal device 20 sends 210 the recommendation information.

In the implementation for grant-based scheduling, the terminal device 20 determines 204 whether the parameter of grant-based scheduling meets the service feature. Correspondingly, the recommendation information includes periodicity information of PDCCH monitoring and/or time domain offset information of PDCCH monitoring for uplink grant-based scheduling.

In some embodiments, the service feature of the uplink data to be transmitted is determined by using a service prediction algorithm. Optionally, the service prediction algorithm used by the terminal device 20 is an AI algorithm, for example, is a conventional machine learning algorithm or deep learning algorithm. For the service prediction algorithm, refer to the related description in the foregoing implementation. Details are not repeated herein.

FIG. 4 is a schematic diagram of a case 400 in which the terminal device 20 determines that a periodicity of PDCCH monitoring of grant-based scheduling does not meet a service feature according to at least one embodiment. As shown in FIG. 4, the network device 10 preconfigures a periodicity of PDCCH monitoring, and correspondingly, PDCCH transmission occasions are represented as TD1, TD2, . . . , TD6, and the like. Uplink data transmitted by the terminal device 20 to the network device 10 includes a packet 1, a packet 2, a packet 3, . . . , a packet 6, and the like. The terminal device 20 determines, in a process of transmitting the packet 1 and the packet 2, a service feature of subsequent uplink data to be transmitted, and determine whether the periodicity of PDCCH monitoring meets the service feature.

For example, the terminal device 20 determines that a time of arrival of the uplink data to be transmitted changes (for example, later), but an arrival periodicity does not change. In this case, based on the preconfigured periodicity of PDCCH monitoring, a waiting time for performing uplink service transmission increases. As a result, an uplink transmission delay increases.

As shown in FIG. 4, in response to the packet 1 at the terminal device 20 being transmitted, the terminal device 20 sends 410 an SR or a BSR to the network device 10. Subsequently, at the PDCCH transmission occasion TD2, the terminal device 20 receives 420 a PUSCH transmission resource configured by the network device 10, and perform uplink transmission on the packet 1. A delay for transmission of the packet 1 is shown in FIG. 4 as Δt3. Similarly, uplink transmission is performed on the packet 2. In some embodiments, in the process of transmitting the packet 1 and the packet 2, the terminal device 20 determines, in a manner such as prediction, that a time of arrival of the packet 3 is delayed, that is, a time interval between the time of arrival of the packet 3 and a time of arrival of the packet 2 is greater than a time interval between those of the packet 2 and the packet 1. In this case, after the packet 3 arrives, the terminal device 20 sends 430 an SR or a BSR to the network device 10. However, because the packet 3 arrives relatively late, and the configured periodicity of PDCCH monitoring remains unchanged, after 430, the terminal device 20 needs to wait until the PDCCH transmission occasion TD5 arrives, then receives 440 a PUSCH transmission resource configured by the network device 10, and performs uplink transmission on the packet 3. A delay for transmission of the packet 3 is shown in FIG. 4 as Δt4. That is, the terminal device 20 predicts that a transmission delay after the packet 3 increases. Therefore, the terminal device 20 determines that the periodicity of PDCCH monitoring does not meet the service feature.

Only some examples are provided above, which are not limitative, and there is other cases in which a parameter of grant-based scheduling cannot meet a service feature of uplink data to be transmitted, which are not listed one by one herein.

For example, the terminal device 20 generates the recommendation information based on the determined service feature of the uplink data to be transmitted and the periodicity and/or the time domain offset of PDCCH monitoring, and further send 210 the recommendation information to the network device 10. In this implementation, the recommendation information indicates a recommendation of the terminal device 20 for a PDCCH configuration. The recommendation information includes periodicity information of PDCCH monitoring and/or time domain offset information of PDCCH monitoring. The periodicity information of PDCCH monitoring indicates a recommendation of the terminal device for a “periodicity of PDCCH monitoring”. The time domain offset information of PDCCH monitoring indicates a recommendation of the terminal device for a “time domain offset” in each “periodicity of PDCCH monitoring”. The time domain offset of PDCCH monitoring is used to determine a specific time domain location of PDCCH monitoring in each monitoring periodicity. Generally, the time domain offset of PDCCH monitoring is less than the periodicity of PDCCH monitoring.

In some embodiments, the recommendation information includes periodicity information of PDCCH monitoring for uplink grant-based scheduling. The recommendation information indicates an update recommendation of the terminal device 20 for a periodicity of PDCCH monitoring for uplink grant-based scheduling. Optionally, the periodicity information of PDCCH monitoring is a specific periodicity preference in the number of slots, the number of symbols, or others. Optionally, the periodicity information of PDCCH monitoring is periodicity increase or decrease indication information of PDCCH monitoring, and is represented in a manner such as a choice (CHOICE) structure or an enumerate (ENUMERATE) structure. Optionally, time domain offset information of PDCCH monitoring is obtained by using a preset offset rule, and the preset offset rule is as follows: A result of performing a modulo operation on an original time domain offset of PDCCH monitoring with respect to an original periodicity of PDCCH monitoring is equal to a result of performing a modulo operation on recommended time domain offset information of PDCCH monitoring with respect to recommended periodicity information of PDCCH monitoring. This is not limited in at least one embodiment.

In this way, the network device 10 obtains, by using the recommendation information, the recommendation of the terminal device 20 for the periodicity of PDCCH monitoring. In some embodiments, the network device 10 determines, based on the recommended periodicity information of PDCCH monitoring and the preset offset rule, the time domain offset information of PDCCH monitoring that is recommended by the terminal device 20. The original periodicity of PDCCH monitoring is represented as TO, the original time domain offset of PDCCH monitoring is represented as Δt01, and the recommended periodicity information of PDCCH monitoring is represented as T1. In this case, the recommended time domain offset information Δt11 of PDCCH monitoring is determined based on MOD(T0, Δt01)=MOD(T1, Δt11). MOD is a modulo operation. For example, the original periodicity of PDCCH monitoring is 10 slots, and the original time domain offset of PDCCH monitoring is 8 slots. The terminal device 20 recommends updating the periodicity of PDCCH monitoring to 5 slots, that is, the recommended periodicity of PDCCH monitoring is 5 slots. In this case, based on the foregoing modulo operation, the recommended time domain offset of PDCCH monitoring is determined to be 3 slots.

In some embodiments, the recommendation information includes time domain offset information of PDCCH monitoring for uplink grant-based scheduling. The recommendation information indicates an update recommendation of the terminal device 20 for a time domain offset of PDCCH monitoring for uplink grant-based scheduling. Optionally, the time domain offset information of PDCCH monitoring is a specific offset preference in the number of slots, the number of symbols, or others. Optionally, the time domain offset information of PDCCH monitoring is a recommendation of increasing or decreasing a monitoring time domain offset. This is not limited in at least one embodiment.

In this way, the network device 10 obtains, by using the recommendation information, the recommendation of the terminal device 20 for the time domain offset of PDCCH monitoring. In some embodiments, in response to the recommendation information including the time domain offset information of PDCCH monitoring, but not including periodicity information of PDCCH monitoring, the network device 10 considers that the terminal device 20 does not recommend modifying or updating a periodicity of PDCCH monitoring. That is, an original periodicity of PDCCH monitoring remains unchanged.

In some embodiments, the recommendation information includes periodicity information of PDCCH monitoring and time domain offset information of PDCCH monitoring for uplink grant-based scheduling. In this way, the network device 10 obtains, by using the recommendation information, recommendations of the terminal device 20 for a periodicity of PDCCH monitoring and a time domain offset of PDCCH monitoring. For example, the recommendations for the two are respectively notified by using a monitoring periodicity preference field and a monitoring time domain offset preference field. Alternatively, a monitoring slot periodicity and offset preference field (monitoringSlotPeriodicityAndOffsetPreference) is used for carrying to notify the recommendations for the two together.

In some embodiments, the recommendation information is carried in a choice (CHOICE) structure. For example, “sl5” is used to indicate that the recommended periodicity of PDCCH monitoring is 5 slots. For example, an integer ““ ”” is used to indicate that the recommended time domain offset of PDCCH monitoring is 3 slots. In some embodiments, the following choice structure is used for carrying, so that protocol overheads between the terminal device 20 and the network device 10 is simplified:

| CHOICE { | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

where NULL represents empty, sl represents a slot, sl followed by a number (for example, M) indicates that the periodicity of PDCCH monitoring is M slots, INTEGER is an integer, a number (assumed to be p) in parentheses after INTEGER indicates that a time domain offset in the periodicity of PDCCH monitoring is p slots, M is a positive integer, and p is an integer less than M.

Optionally, the time domain offset information of PDCCH monitoring is monitoring time domain offset increase or decrease indication information, and is represented in a manner such as a choice (CHOICE) structure or an enumerate (ENUMERATE) structure. This is not limited in at least one embodiment.

The foregoing separately describes the implementation for grant-free scheduling and the implementation for grant-based scheduling. In the implementation for grant-free scheduling, the recommendation information includes periodicity information and/or time domain offset information for grant-free scheduling. In the implementation for grant-based scheduling, the recommendation information includes periodicity information of PDCCH monitoring and/or time domain offset information of PDCCH monitoring for grant-based scheduling. However, embodiments described herein are not limited thereto. For both the implementation for grant-free scheduling and the implementation for the grant-based scheduling, in some embodiments, the recommendation information further includes other information. The other information in at least one embodiment includes the following for uplink transmission: a number of repetitions, an MCS, spectral efficiency of an MCS, validity time information, probability information, target information, reward feedback information, or any combination thereof.

In some embodiments, the recommendation information includes the number of repetitions, to indicate a recommendation for the number of retransmissions supported for uplink transmission. Optionally, the number of repetitions is a specific value of the number of repetitions. The number of repetitions is carried in a number-of-repetitions preference field (repKPreference). For a value range of the number of repetitions, refer to a range in a downlink configuration. For example, enumerated ENUMERATED {n1, n2, n4, n8} indicates that the number of repetitions is 1, 2, 4, or 8, respectively. Optionally, the number of repetitions is number-of-repetitions increase or decrease indication information, and is represented in a manner such as a choice (CHOICE) structure or an enumerate (ENUMERATE) structure. This is not limited in at least one embodiment.

In some embodiments, the recommendation information includes a modulation and coding scheme (MCS), to indicate a recommendation for an MCS of uplink transmission. Optionally, the MCS is a specific MCS value. The MCS is carried in an MCS and transport block size (TBS) preference field (mcsAndTBSPreference). For a value range of the MCS, refer to a range in a downlink configuration, for example, an integer INTEGER (0 . . . 31). Optionally, the MCS is MCS increase or decrease indication information, and is represented in a manner such as a choice (CHOICE) structure or an enumerate (ENUMERATE) structure, to obtain an actually transmitted transport block size (TBS). This is not limited in at least one embodiment.

In some embodiments, the recommendation information includes spectral efficiency of an MCS, to indicate a recommendation for spectral efficiency of an MCS of uplink transmission. Optionally, the spectral efficiency of the MCS is a specific MCS table, and the spectral efficiency of the MCS is carried in an MCS table preference field (mes-TablePreference). For a value range of the spectral efficiency of the MCS, refer to a range in a downlink configuration. For example, ENUMERATED {qam256, gam64LowSE} respectively represents quadrature amplitude modulation (QAM) 256 and quadrature amplitude modulation (QAM) 64 low spectral efficiency (SE). Optionally, the spectral efficiency of the MCS is spectral efficiency increase or decrease indication information, and is represented in a manner such as a choice (CHOICE) structure or an enumerate (ENUMERATE) structure. This is not limited in at least one embodiment.

In some embodiments, the recommendation information includes a recommendation for an uplink transmission resource scheduled by the network device 10. For example, the recommendation information includes at least one of redundancy version information, demodulation reference signal information, power control, or other information, which is not listed one by one in embodiments described herein.

In some embodiments, additionally, the recommendation information further includes: validity time information, probability information, target information, reward feedback information, or any combination thereof.

In this way, in response to receiving the recommendation information, the network device 10 also obtains some reference information used in response to the terminal device 20 determining the recommendation information, so that the network device 10 determines a configuration parameter by considering more comprehensive reference information, thereby improving accuracy.

In some embodiments, the recommendation information further includes validity time information, to indicate a validity time of the recommendation for uplink scheduling. That is, after the validity time expires, the recommendation information is considered invalid or having no reference value. Specifically, in response to prediction being performed by using the AI algorithm, a validity time corresponding to (1) the periodicity information and/or the time domain offset information for uplink grant-free scheduling or (2) the periodicity information of PDCCH monitoring and/or the time domain offset information of PDCCH monitoring for uplink grant-based scheduling is obtained. For example, the validity time information is carried in an enumerate (ENUMERATE) structure. The validity time information is alternatively carried in another similar or completely different structure. This is not limited in at least one embodiment. For example, an enumerate structure m0.1, m0.2, m0.5, m1, m2, m4, m8, or m10 is used to respectively indicate a validity time of 0.1 minute, 0.2 minute, 0.5 minute, 1 minute, 2 minutes, 4 minutes, 8 minutes, or 10 minutes.

In some embodiments, the recommendation information further includes probability information, to indicate confidence in the recommendation for uplink scheduling. Specifically, in response to performing prediction by using the AI algorithm, the terminal device 20 obtains a plurality of prediction results and probability information corresponding to the plurality of prediction results.

The implementation for uplink grant-free scheduling is used as an example. For example, the terminal device 20 determines periodicity information T11 and corresponding probability information P11, and periodicity information T12 and corresponding probability information P12. For another example, the terminal device 20 determines periodicity information T11 and time domain offset information ΔT21, and corresponding probability information P21. For example, the recommendation information includes a preset number of groups with maximum probability information. For example, the preset number is N1. In this case, the probability information is sorted in descending order, to obtain the first N1 groups as the recommendation information. An example is shown in Table 1.

TABLE 1

| | Probability |
|---|---|
| Recommendation for uplink grant-free scheduling | information |
| Periodicity information T11 | P11 |
| Periodicity information T12 | P12 |
| Periodicity information T11 and time domain | P21 |
| offset information ΔT21 | |
| . . . | . . . |

The implementation for uplink grant-based scheduling is used as an example. For example, the terminal device 20 determines periodicity information T31 of PDCCH monitoring and corresponding probability information P31, and periodicity information T32 of PDCCH monitoring and corresponding probability information P32. For another example, the terminal device 20 determines periodicity information T31 of PDCCH monitoring and time domain offset information ΔT41 of PDCCH monitoring, and corresponding probability information P41. For example, the recommendation information includes a preset number of groups with maximum probability information. For example, the preset number is N2. In this case, the probability information is sorted in descending order, to obtain the first N2 groups as the recommendation information. An example is shown in Table 2.

TABLE 2

| | Probability |
|---|---|
| Recommendation for uplink grant-based scheduling | information |
| Periodicity information T31 of PDCCH monitoring | P31 |
| Periodicity information T32 of PDCCH monitoring | P32 |
| Periodicity information T31 of PDCCH monitoring | P41 |
| and time domain offset information ΔT41 of | |
| PDCCH monitoring | |
| . . . | . . . |

For example, the probability information is represented by using an enumerate structure of a first preset length. For example, any one of the following probabilities is represented by using a 4-bit enumerate structure: 0%, 5%, 10%, 15%, 20%, 30%, 37%, 44%, 50%, 56%, 63%, 70%, 80%, 90%, 95%, or 100%. For example, the probability information is alternatively represented by using a 5-bit enumerate structure. For example, an intermediate value is added in the probability information represented by the foregoing 4 bits. The validity time and/or the probability information is alternatively carried in another structure or manner. This is not limited in at least one embodiment.

In an embodiment, the recommendation information further includes target information, to indicate a target on which the recommendation for uplink scheduling is based. Specifically, in response to the terminal device 20 performing prediction by using the AI algorithm, the recommendation is obtained for a specific target. In this case, the target information is a target used in response to the recommendation is obtained. For example, the target information includes: an energy saving target, a low latency target, a high reliability target, or the like.

For example, the target information is represented by using an enumerate structure of a second preset length. In an example, the target information is carried in a 1-bit enumerate structure. For example, “0” indicates the energy saving target, and “1” indicates the low latency target. In another example, the target information is carried in a 2-bit enumerate structure, “00” represents the energy saving target, “01” represents the low latency target, and “10” represents the high reliability target. In addition, the target information is alternatively carried in another structure or manner. This is not limited in at least one embodiment.

In an embodiment, the recommendation information further includes reward feedback information, to indicate an observation result obtained in response to the terminal device 20 determining the recommendation for uplink scheduling, for example, a reward feedback that is to be provided by the network device 10 to the terminal device 20 and that is determined in response to the terminal device 20 determining the recommendation information. Specifically, in response to performing prediction by using the AI algorithm (such as reinforcement learning), the terminal device 20 simultaneously predicts a reward feedback to be obtained.

For example, the reward feedback information is represented by using an enumerate structure of a third preset length. For example, the reward feedback information is carried in a 10-bit enumerate structure, for example, representing −1024, −1022, . . . , 1022, or 1024. Optionally, a maximum value of the reward feedback information is preconfigured by the network device 10, for example, is 1024. In addition, the reward feedback information is alternatively carried in another structure or manner. This is not limited in at least one embodiment.

Although the foregoing separately shows the “first preset length”, the “second preset length”, and the “third preset length”, the three are able to not be equal to each other. Actually, the “first”, the “second”, and the “third” in at least one embodiment are independent of each other. For example, the three is unequal to each other, or two or all of them are equal to each other. This is not limited in at least one embodiment.

Based on the foregoing description, in at least one embodiment, the recommendation information includes (1) periodicity information and/or time domain offset information for uplink grant-free scheduling or (2) periodicity information of PDCCH monitoring and/or time domain offset information of PDCCH monitoring for uplink grant-based scheduling, and further includes at least one of the following for uplink transmission: a number of repetitions, an MCS, spectral efficiency of an MCS, validity time information, probability information, target information, or reward feedback information. For example, categories included in the recommendation information is indicated by using an uplink configured preference list (UplinkConfiguredPreferenceList).

In some embodiments, the categories included in the recommendation information and the number of pieces of recommendation information is indicated. For example, the categories included in the recommendation information are periodicity information for uplink grant-free scheduling, time domain offset information for uplink grant-free scheduling, validity time information, probability information, target information, and reward feedback information. The number of pieces of recommendation information is N. N is a positive integer.

Using N=3 as an example, the recommendation information includes the following three groups: (1) periodicity information 1, time domain offset information 1, validity time information 1, probability information 1, target information 1, and reward feedback information 1; (2) periodicity information 2, time domain offset information 2, validity time information 2, probability information 2, target information 2, and reward feedback information 2; and (3) periodicity information 3, time domain offset information 3, validity time information 3, probability information 3, target information 3, and reward feedback information 3.

In this way, the network device 10 accurately learns the categories included in the recommendation information in the RRC message, so that parsing and processing is performed more quickly, and processing efficiency is improved.

As shown in FIG. 2, in some embodiments, the network device 10 determines 220 a configuration parameter of uplink scheduling based on the recommendation information.

Specifically, the network device 10 determines 220 the configuration parameter of uplink scheduling based on the recommendation information and a load status of the network device 10.

In the implementation for grant-free scheduling, the configuration parameter includes a periodicity update configuration parameter and/or a time domain offset update configuration parameter for grant-free scheduling. In the implementation for grant-based scheduling, the configuration parameter includes a periodicity update configuration parameter of PDCCH monitoring and a time domain offset update configuration parameter of PDCCH monitoring for grant-based scheduling.

In some embodiments, the configuration parameter further includes another parameter for uplink transmission, such as the number of repetitions, an MCS, spectral efficiency of an MCS, a redundancy version, power control, or any combination thereof.

In some embodiments, the configuration parameter is also referred to as an air interface parameter, an air interface configuration parameter, or the like. This is not limited in at least one embodiment. In this way, in at least one embodiment, the network device 10 considers the recommendation information of the terminal device 20 in response to determining the configuration parameter, so that the determined configuration parameter meets a usage parameter of the terminal device 20, for example, meet a usage parameter of the terminal device 20 for a low latency of an uplink service or energy saving.

In this way, in at least one embodiment, in response to performing uplink scheduling for uplink transmission of the terminal device 20, the network device 10 simultaneously considers the recommendation information from the terminal device 20, so that information on both sides of the terminal device 20 and the network device 10 is considered more comprehensively during uplink scheduling, thereby ensuring accuracy during scheduling.

As shown in FIG. 2, in some embodiments, the network device 10 sends 230 the configuration parameter to the terminal device 20. The configuration parameter is determined by the network device 10 based on the recommendation information and the load status of the network device 10.

In some embodiments, the network device 10 sends an RRC reconfiguration message to the terminal device 20. The RRC reconfiguration message includes the configuration parameter. In other words, the configuration parameter is included in an RRC reconfiguration message.

Additionally or alternatively, as shown in FIG. 2, in some embodiments, the method further includes: The terminal device 20 updates 232 the configuration parameter for uplink transmission, and optionally performs uplink data transmission based on an updated configuration parameter.

Therefore, in embodiments described with reference to FIG. 2 to FIG. 4, the terminal device 20 sends the recommendation information for uplink scheduling to the network device 10 based on a feature of an uplink service to be transmitted by the terminal device 20, so that the network device 10 adjusts or updates the configuration parameter of uplink scheduling in time based on the recommendation information. In at least one embodiment, the network device 10 considers more comprehensive information in response to determining the configuration parameter, so that the determined configuration parameter of uplink scheduling is more accurate, and optimized resource utilization is further facilitated. In this manner, in response to determining the configuration parameter of uplink scheduling, the network device considers information of both the terminal device and the network device, thereby ensuring timely transmission of the service of the terminal device, and reducing a delay.

FIG. 5 is a schematic block diagram of a communications apparatus 500 according to at least one embodiment. The communications apparatus 500 is implemented as the terminal device 20 or a chip in the terminal device 20. The scope at least one embodiment is not limited in this aspect. The communications apparatus 500 is implemented as the terminal device 20 in the foregoing embodiments or a part of the terminal device 20.

As shown in the figure, the communications apparatus 500 includes a sending unit 510, configured to send recommendation information to the network device 10. The recommendation information indicates a recommendation of the terminal device 20 for performing uplink scheduling by the network device 10. The communications apparatus 500 further includes a receiving unit 520, configured to receive a configuration parameter of uplink scheduling from the network device 10.

In some embodiments, the sending unit 510 is configured to send an RRC message to the network device 10. The RRC message includes the recommendation information, and the RRC message is one of the following messages: an RRC connection resume complete message, an RRC setup complete message, an RRC reconfiguration complete message, or an RRC recommendation message. Optionally, the RRC message is alternatively an AI assistance message or another RRC message.

In some embodiments, the recommendation information includes at least one of the following for uplink grant-free scheduling: periodicity information or time domain offset information.

In some embodiments, the recommendation information includes at least one of the following for uplink grant-based scheduling: periodicity information of physical downlink control channel PDCCH monitoring or time domain offset information of PDCCH monitoring.

In some embodiments, the recommendation information includes at least one of the following for uplink transmission: a number of repetitions, a modulation and coding scheme MCS, or spectral efficiency of an MCS.

In some embodiments, the recommendation information further includes at least one of the following: validity time information, probability information, target information, or reward feedback information.

The communications apparatus 500 in FIG. 5 is configured to perform the foregoing processes implemented by the terminal device 20 in the foregoing embodiment with reference to FIG. 2. To avoid repetition, details are not described herein again.

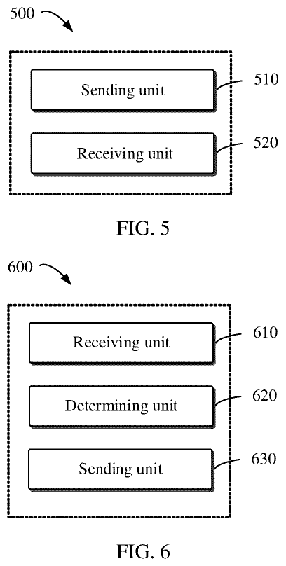

FIG. 6 is a schematic block diagram of a communications apparatus 600 according to at least one embodiment. The communications apparatus 600 is implemented as the network device 10 or a chip in the network device 10. The scope of at least one embodiment is not limited in this aspect. The communications apparatus 600 is implemented as the network device 10 in the foregoing embodiments or a part of the network device 10.

As shown in the figure, the communications apparatus 600 includes a receiving unit 610, configured to receive recommendation information from the terminal device 20. The recommendation information indicates a recommendation of the terminal device 20 for performing uplink scheduling by the network device 10. The communications apparatus 600 further includes a determining unit 620, configured to determine a configuration parameter of uplink scheduling based on the recommendation information. The communications apparatus 600 further includes a sending unit 630, configured to send the configuration parameter to the terminal device 20.

In some embodiments, the receiving unit 610 is configured to receive an RRC message from the terminal device 20. The RRC message includes the recommendation information, and the RRC message is one of the following messages: an RRC connection resume complete message, an RRC setup complete message, an RRC reconfiguration complete message, and an RRC recommendation message. Optionally, the RRC message is alternatively an AI assistance message or another RRC message.

In some embodiments, the recommendation information includes at least one of the following for uplink grant-free scheduling: periodicity information or time domain offset information.

In some embodiments, the recommendation information includes at least one of the following for uplink grant-based scheduling: periodicity information of physical downlink control channel PDCCH monitoring or time domain offset information of PDCCH monitoring.

In some embodiments, the recommendation information includes at least one of the following for uplink transmission: the number of repetitions, a modulation and coding scheme MCS, or spectral efficiency of an MCS.

In some embodiments, the recommendation information further includes at least one of the following: validity time information, probability information, target information, or reward feedback information.

In some embodiments, the determining unit 620 is configured to determine the configuration parameter based on the recommendation information and a load status of the network device 10.

The communications apparatus 600 in FIG. 6 is configured to perform the foregoing processes implemented by the network device 10 in the foregoing embodiment with reference to FIG. 2. To avoid repetition, details are not described herein again.

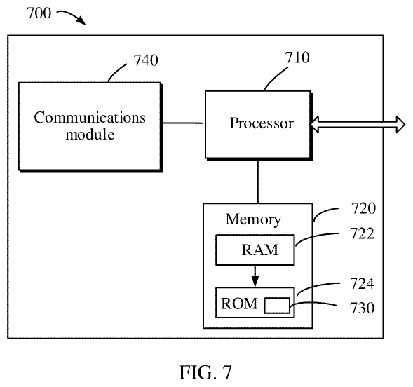

FIG. 7 is a simplified block diagram of an example device 700 according to at least one embodiment. The device 700 is configured to implement the terminal device 20 or the network device 10 shown in FIG. 1. As shown in the figure, the device 700 includes one or more processors 710, one or more memories 720 coupled to the processor 710, and a communications module 740 coupled to the processor 710.

The communications module 740 is configured for bidirectional communication. The communications module 740 has at least one communications interface for communication. The communications interface includes any interface used to communicate with other devices.

The processor 710 is of any type suitable for a local technology network, and includes but not limited to at least one of the following: a general-purpose computer, a dedicated computer, a microcontroller, a digital signal processor (DSP), or a controller-based multi-core controller architecture. The device 700 has a plurality of processors, such as application-specific integrated circuit chips, which in time belong to a clock synchronized with a main processor.

The memory 720 includes one or more non-volatile memories and one or more volatile memories. An example of the non-volatile memory includes but is not limited to at least one of the following: a read-only memory (ROM) 724, an erasable programmable read-only memory (EPROM), a flash memory, a hard disk, a compact disc (CD), a digital versatile disc (DVD), or other magnetic storages and/or optical storages. An example of the volatile memory includes but is not limited to at least one of the following: a random access memory (RAM) 722, or another volatile memory that does not persist during a power failure.

A computer program 730 includes computer-executable instructions for execution by an associated processor 710. The program 730 is stored in the ROM 720. The processor 710 performs any appropriate actions and processing by loading the program 730 into the RAM 720.

At least one embodiment is implemented by using the program 730, so that the device 700 performs any one of the processes discussed with reference to FIG. 2. At least one embodiment is alternatively implemented by using hardware or by using a combination of software and hardware.

In some embodiments, the program 730 is tangibly included in a computer-readable medium, and the computer-readable medium is included in the device 700 (for example, in the memory 720) or other storage devices that is accessed by the device 700. The program 730 is loaded from the computer-readable medium to the RAM 722 for execution. The computer-readable medium includes any type of tangible non-volatile memory, such as a ROM, an EPROM, a flash memory, a hard disk, a CD, or a DVD.

Generally, at least one embodiment is implemented by using hardware or a dedicated circuit, software, logic, or any combination thereof. Some aspects is implemented by using hardware, while other aspects is implemented by using firmware or software, which is performed by a controller, a microprocessor, or another computing device. Although various aspects of embodiments described herein are shown and described as block diagrams, flowcharts, or represented by using some other diagrams, the blocks, apparatuses, systems, techniques, or methods described herein is implemented as, for example rather than limitation, hardware, software, firmware, dedicated circuitry or logic, general-purpose hardware or controllers, or other computing devices, or a combination thereof.

At least one embodiment further provides at least one computer program product that is tangibly stored in a non-transitory computer-readable storage medium. The computer program product includes computer-executable instructions, for example, instructions included in program modules, which are executed in a device on a target real or virtual processor to perform the foregoing process/method with reference to FIG. 2. Generally, the program modules include routines, programs, libraries, objects, classes, components, data structures, and the like that perform specific tasks or implement specific abstract data types. In various embodiments, functions of the program modules is combined or split between the program modules as desired. Machine-executable instructions for the program modules is executed locally or in a distributed device. In the distributed device, the program modules is located in local and remote storage media.

Computer program code for implementing the method of at least one embodiment is written in one or more programming languages. The computer program code is provided to a processor of a general-purpose computer, a dedicated computer, or another programmable data processing apparatus, so that in response to the program code being executed by the computer or the another programmable data processing apparatus, a function/operation specified in a flowchart and/or a block diagram is implemented. The program code is executed entirely on a computer, partly on a computer, as a standalone software package, partly on a computer and partly on a remote computer, or entirely on a remote computer or server.

In the context of at least one embodiment, computer program code or related data is carried by any appropriate carrier to enable a device, an apparatus, or a processor to perform various processing and operations described above. Examples of the carrier include a signal, a computer-readable medium, and the like. Examples of the signal includes electrical, optical, radio, acoustic, or other forms of propagated signals, such as a carrier wave or an infrared signal.

The computer-readable medium is any tangible medium that contains or stores programs for or related to an instruction execution system, apparatus, or device. The computer-readable medium is a computer-readable signal medium or a computer-readable storage medium. The computer-readable medium includes but is not limited to electronic, magnetic, optical, electromagnetic, infrared, or semiconductor systems, apparatuses, or devices, or any appropriate combination thereof. More detailed examples of the computer-readable storage medium include an electrical connection with one or more wires, a portable computer disk, a hard disk, a random access memory (RAM), a read-only memory (ROM), an erasable programmable read-only memory (EPROM or flash memory), an optical storage device, a magnetic storage device, or any appropriate combination thereof.

Besides, although operations of the method in at least one embodiment are described in a specific order in the accompanying drawings, these operations are able to be performed in some order, or all of the operations shown need to be performed to achieve a desired result. Instead, steps depicted in the flowchart is performed in a different order. Additionally or alternatively, some steps is omitted, a plurality of steps is combined into one step for execution, and/or one step is split into a plurality of steps for execution. Features and functions of two or more devices according to at least one embodiment is embodied in one device. Conversely, a feature and a function of one apparatus described above is further divided into embodiments of a plurality of apparatuses.

Implementations of at least one embodiment have been described above. The foregoing description is illustrative rather than exhaustive, and at least one embodiment is not limited to the implementations disclosed. Many modifications and changes are apparent to a person of ordinary skill in the art without departing from the scope and spirit of the described implementations. Terms used in this specification are selected to well explain principles or actual applications of each implementation or improvements to technologies in the market, or enable another person of ordinary skill in the art to understand each implementation disclosed in this specification.

1. A communications method, comprising:
sending, by a terminal device, recommendation information to a network device, wherein the recommendation information indicates a recommendation of the terminal device for performing uplink scheduling by the network device; and
receiving, by the terminal device, a configuration parameter of uplink scheduling from the network device.

2. The communications method according to claim 1, wherein the sending the recommendation information includes sending the following for uplink grant-free scheduling: periodicity information or time domain offset information.

3. The communications method according to claim 1, wherein the sending the recommendation information includes sending the following for uplink grant-based scheduling: periodicity information of physical downlink control channel (PDCCH) monitoring or time domain offset information of PDCCH monitoring.

4. The communications method according to claim 1, wherein the sending the recommendation information including sending the following for uplink transmission: a number of repetitions, a modulation and coding scheme MCS, or spectral efficiency of an MCS.

5. The communications method according to claim 1, wherein the sending the recommendation information further includes sending:
validity time information,
probability information,
target information, or
reward feedback information.

6. The communications method according to claim 1, wherein the sending the recommendation information further includes:
sending, by the terminal device, a radio resource control RRC message to the network device, wherein the RRC message includes the recommendation information, and the RRC message is one of the following messages: an RRC connection resume complete message, an RRC connection setup complete message, an RRC connection reconfiguration complete message, and an RRC recommendation message.

7. A communications method, comprising:
receiving, by a network device, recommendation information from a terminal device, wherein the recommendation information indicates a recommendation of the terminal device for performing uplink scheduling by the network device;
determining, by the network device, a configuration parameter of uplink scheduling based on the recommendation information; and
sending, by the network device, the configuration parameter to the terminal device.

8. The communications method according to claim 7, wherein the receiving the recommendation information includes receiving the following for uplink grant-free scheduling: periodicity information or time domain offset information.

9. The communications method according to claim 7, wherein the receiving the recommendation information includes receiving the following for uplink grant-based scheduling: periodicity information of physical downlink control channel (PDCCH) monitoring or time domain offset information of PDCCH monitoring.

10. The communications method according to claim 7, wherein the receiving the recommendation information includes receiving the following for uplink transmission: a number of repetitions, a modulation and coding scheme MCS, or spectral efficiency of an MCS.

11. The communications method according to claim 7, wherein the receiving the recommendation information further includes receiving:
validity time information,
probability information,
target information, or
reward feedback information.

12. The communications method according to claim 7, wherein the receiving the recommendation information includes:
receiving, by the network device, a radio resource control RRC message from the terminal device, wherein the RRC message includes the recommendation information, and the RRC message is one of the following messages: an RRC connection resume complete message, an RRC connection setup complete message, an RRC connection reconfiguration complete message, and an RRC recommendation message.

13. The communications method according to claim 7, wherein the determining the configuration parameter includes:
determining, by the network device, the configuration parameter based on the recommendation information and a load status of the network device.

14. An apparatus, comprising:
memory storing instructions; and
a processor, coupled to the memory, wherein the processor is configured to execute the instructions to cause the processor to perform the operations of:
sending, by a terminal device, recommendation information to a network device, wherein the recommendation information indicates a recommendation of the terminal device for performing uplink scheduling by the network device; and
receiving, by the terminal device, a configuration parameter of uplink scheduling from the network device.

15. The apparatus according to claim 14, wherein the recommendation information includes the following for uplink grant-free scheduling: periodicity information or time domain offset information.

16. The apparatus according to claim 14, wherein the recommendation information includes the following for uplink grant-based scheduling: periodicity information of physical downlink control channel (PDCCH) monitoring or time domain offset information of PDCCH monitoring.

17. The apparatus according to claim 14, wherein the recommendation information includes the following for uplink transmission: a number of repetitions, a modulation and coding scheme MCS, or spectral efficiency of an MCS.

18. The apparatus according to claim 14, wherein the recommendation information further includes:
validity time information,
probability information,
target information, or
reward feedback information.

19. The apparatus according to claim 14, wherein the processor is further configured to perform the operation of:
sending, by the terminal device, a radio resource control RRC message to the network device, wherein the RRC message includes the recommendation information, and the RRC message is one of the following messages: an RRC connection resume complete message, an RRC connection setup complete message, an RRC connection reconfiguration complete message, and an RRC recommendation message.
